(19) United States
(12) Patent Application Publication
(10) Pub. No.: US 2004/0158612 A1
(43) Pub. Date: Aug. 12, 2004

(54) System and method for electronic materials distribution and tracking

(75) Inventor: Chris Concannon, Brooklyn, NY (US)

Correspondence Address: OSTROLENK FABER GERB & SOFFEN, 1180 AVENUE OF THE AMERICAS, NEW YORK, NY, 100368403

(73) Assignee: Optima Printing

(21) Appl. No.: 10/717,699

(22) Filed: Nov. 19, 2003

Related U.S. Application Data
(60) Provisional application No. 60/427,902, filed on Nov. 19, 2002.

(51) Int. Cl. G06F 15/16

(52) U.S. Cl. 709/206; 709/218

(57) ABSTRACT

A system and method for disseminating an electronic material over a network. Included is a list defining module that defines a list of at least one intended recipient of the electronic material. An electronic materials receiving module receives and stores the electronic material from a user to be transmitted to the at least one intended recipient on a site processor. A properties association module defines properties to be associated with the electronic material. A generate and send message module provides a message to the at least one intended recipient, wherein the message includes a hyperlink to the electronic material. A system tracking module tracks whether the at least one intended recipient receives the electronic material.

### CROSS REFERENCE TO RELATED APPLICATION

This application is based on and claims priority to U.S. Provisional Patent Application No. 60/427,902, filed on Nov. 19, 2002 and entitled SYSTEM AND METHOD FOR ELECTRONIC MATERIALS DISTRIBUTION AND TRACKING, the entire contents of which is incorporated herein by reference.

### BACKGROUND OF THE INVENTION

1. Field of The Invention

The present invention relates to electronic document distribution and tracking, and more particularly, is directed to distributing electronic materials via an Internet web site.

2. Description of the Related Art

Methods of transmitting electronic documents and other files over the Internet are well known. Largely due to the ease of use and convenience, attaching an electronic document or other file to an e-mail message is one of the most preferred methods of distributing electronic documents and files. In order to distribute electronic materials simultaneously to a plurality of parties, e-mail client software, such as MICROSOFT OUTLOOK or NETSCAPE MESSENGER, is used to create e-mail groups, usually in an e-mail address book. For example, a user enters names and corresponding e-mail addresses in an e-mail address book, and then associates the entries into specific groups. When a message is sent to the group, everyone associated with the group is expected to receive the message.

Although distributing electronic materials to e-mail groups may be convenient for private individuals, it is impractical for a plurality of users on a large corporate level. Successful distribution of classified, confidential or other sensitive materials to a large number of recipients over the Internet is difficult to ensure using prior art e-mail client software.

The financial investment industry frequently distributes time-sensitive information, often to a large number of recipients. For example, annual reports, bank books, compliance documents, litigation-related materials, mutual fund-related information, Preliminary Official Statements, private placements, prospectuses, proxy statements, registration statements and research reports are distributed in electronic form throughout the year. Often, e-mail groups defined in prior art e-mail client software are used to distribute the electronic materials. Occasionally, one or more e-mail addresses in an e-mail group is inaccurately entered or otherwise invalid, and, therefore, the likelihood that the electronic materials successfully reach all of the sender's desired end points within a desired time frame is decreased.

Also, typically, prior art e-mail client software performs very few security measures, such as encryption algorithms, on attachments. Accordingly, e-mail attachments are either unprotected, or minimally protected. Moreover, typical e-mail client software applications do not provide adequate tracking to ensure that electronic materials that are distributed via e-mail are successfully received and read, or that the party receiving the electronic materials is, in fact, the sender's intended party.

### SUMMARY OF THE INVENTION

There is a need in the industry for a solution to the above-identified problems associated with prior art methods of disseminating electronic materials. The present invention is directed to a system and method for providing secure and timely distribution of electronic materials to one or more recipients.

The present invention preferably includes a database that is accessible by registered users. A registered user uses the database to define lists of e-mail recipients, and stores electronic materials including, for example, ADOBE PDF documents, electronic spreadsheets, electronic documents, electronic graphic files, multimedia files, and other on-line materials on a site processor to be distributed to e-mail recipients. In an example embodiment, the present invention enables registered users to perform at least the following tasks: define and modify e-mail lists of recipients, generate and send e-mail messages to members of the e-mail lists, receive electronic materials to be transmitted to members of the e-mail lists, provide descriptive information directed to the electronic materials, track system usage and manage other users' use of features provided by the present invention.

Also provided by the present invention is e-mail address verification. Preferably, the invention examines names in uploaded e-mail lists to verify they are valid. For example, the presence of duplicate names or other details that don't match standard e-mail formatting is checked. If any e-mail address requires removal, for example, because it is improperly formatted, then a message is preferably provided to a registered user that notifies the user of the removal of the name.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example arrangement of the parties in accordance with the present invention;

FIG. 2A shows an example e-mail message received in accordance with the present invention;

FIG. 2B show an example e-mail message that includes a disclaimer and a hyperlink for access to electronic materials;

FIG. 3 shows an example display screen that includes controls for forwarding the e-mail message of FIGS. 2A and 2B to a recipient;

FIG. 4 presents an example display screen presenting a legal disclaimer to a recipient who is receiving electronic materials in accordance with the present invention;

FIG. 5 is an example display screen presented to a recipient and used for accessing electronic material;

FIG. 6 shows an example display screen presented to registered users for utilizing administrative functionality in accordance with the present invention;

FIG. 7A shows a display screen used for managing an e-mail list in accordance with the present invention;

FIG. 7B shows an example display screen that provides help for users managing e-mail lists;

FIG. 8 shows an example display screen for creating e-mail and links to electronic materials in accordance with the present invention;

FIG. 9A is an example display screen for duplicating an existing e-mail message in accordance with the present invention;

FIG. 9B shows an example display screen that provides help for users duplicating e-mail in accordance with the present invention;

FIG. 10A illustrates an example display screen for uploading information that is presented to registered users who are distributing electronic material in accordance with the present invention;

FIG. 10B shows an example display screen that provides help for users uploading electronic materials in accordance with the present invention;

FIG. 11 shows an example display screen for defining properties associated with electronic materials distributed in accordance with the present invention;

FIG. 12A shows an example display screen for reviewing tracking distribution of electronic materials information in accordance with the present invention;

FIG. 12B shows an example display screen that provides help for users reviewing tracking information in accordance with the present invention;

FIG. 13 shows an example display screen that includes a table displaying tracking information of electronic materials distributed via the present invention;

FIG. 14 is an example display screen for managing signature files in accordance with the present invention;

FIG. 15A shows an example display screen for reviewing and adding users in accordance with the present invention;

FIG. 15B shows an example display screen that provides help for users reviewing and adding users in accordance with the present invention;

FIG. 16A is an example review billing display screen presented to a registered user for defining billing review display in accordance with the present invention; and

FIG. 16B is an example display screen that shows a table of projects, amounts due and amounts paid.

### DETAILED DESCRIPTION OF THE PREFERRED EMBODIMENTS

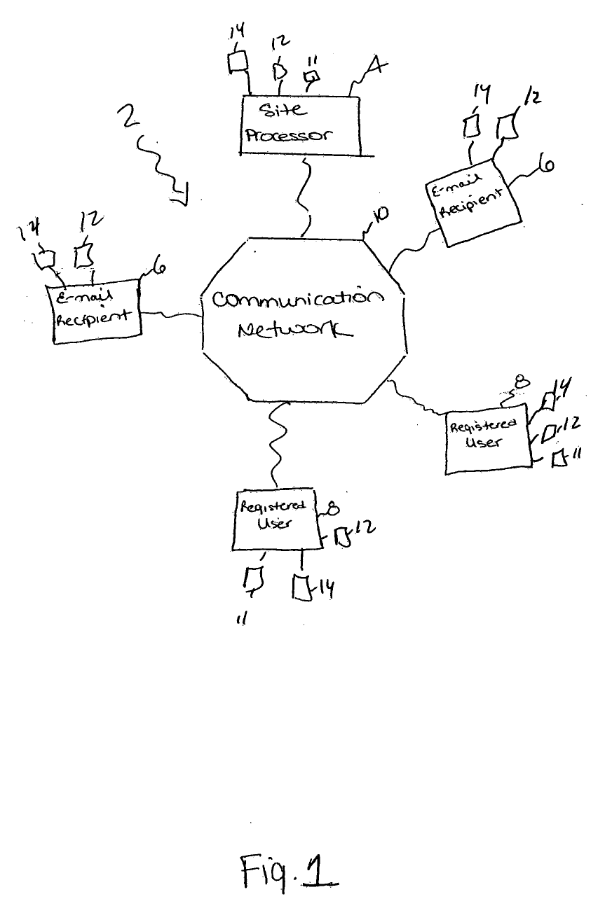

The present invention provides a system and method for providing a secure method for distributing electronic materials to one or more recipients defined in a list by the sender. Referring to the drawing figures in which like reference numerals refer to like elements, there is shown in FIG. 1 a diagram of an example electronic materials document management and tracking system constructed in accordance with the present invention and designated generally as “system 2.” As shown in FIG. 1, system 2 is preferably comprised of one or more site processors 4 that are coupled to one or more e-mail recipients 6 and registered users 8 across communication network 10.

Also shown in FIG. 1, e-mail projects 11 (described below) and electronic materials 12 are provided, for example, from registered user 8 via site processor 4 to e-mail recipient 6. Site processor 4 preferably includes all necessary databases for the present invention. However, it is contemplated that site processor 4 can access required databases via communication network 10 or any other communication network to which site processor 4 may be coupled. Communication network 10 is preferably a global public communication network such as the Internet, but can also be a wide area network (WAN), local area network (LAN), or other network that enables two or more computers to communicate with each other.

As used herein, the terms “user” and/or “user terminal” refer, generally, to a person and/or device operated by a person that establishes a communication session over a network with another device.

In an example embodiment, site processor 4 and user terminals operated by e-mail recipients 6 and registered users 8 are any devices that are capable of sending and receiving data across communication network 10, e.g., mainframe computers, mini computers, personal computers, laptop computers, personal digital assistants (PDA) and Internet access devices such as Web TV. In addition, site processor 4 and user terminals are preferably equipped with a web browser, such as MICROSOFT INTERNET EXPLORER, NETSCAPE NAVIGATOR or the like. Site processors 4 and user terminals are coupled to communication network 10 using any known data communication networking technology.

The functional elements of site processor 4 include one or more central processing units (CPU) used to execute software code and control the operation of site processor 4, read-only memory (ROM), random access memory (RAM), one or more network interfaces to transmit and receive data to and from other computing devices across communication network 10, storage devices such as a hard disk drive, floppy disk drive, tape drive, CD ROM or DVD for storing program code databases and application data, one or more input devices such as a keyboard, mouse, track ball, microphone and the like, and a display.

The various components of site processor 4 need not be physically contained within the same chassis or even in a single location. For example, the storage device may be located at a site which is remote from the remaining elements of site processor 4, and may even be connected to the CPU across communication network 10 via a network interface. Site processor 4 preferably includes a memory equipped with sufficient storage to provide the necessary databases, forums, and other services as well as acting as a web server for communicating hypertext markup language (HTML), Java applets, Active-X control programs or the like to user terminals. Site processor 4 is arranged with components, suitable for the expected operating environment of site processor 4. The CPU(s), network interface(s) and memory and storage devices are selected to ensure that capacities are arranged to accommodate expected demand.

As used herein, the terms “link” and “hyperlink” refer to a selectable connection from one or more words, pictures or other information objects to others in which the selectable connection is presented within the web browser. The information object can include sound and/or motion video. Selection is typically made by “clicking” on the link using an input device such as a mouse, track ball, touch screen and the like. Of course, one of ordinary skill in the art will appreciate that any method by which an object presented on the screen can be selected is sufficient.

The functional elements of site processor 4 are of the same categories of functional elements present in user terminals. However, not all elements need be present in the user terminal and/or site processor 4. For example, storage devices, in the case of PDA's, and the capacities of the various elements are arranged to accommodate the expected user demand. For example, a CPU in user terminal may be a smaller capacity CPU than the CPU present in site processor 4. Similarly, it is likely that site processor 4 will include storage devices of a much higher capacity than storage devices present in user terminal. Of course, one of ordinary skill in the art will understand that the capabilities of the functional elements can be adjusted as needed.

The nature of the invention is such that one skilled in the art of writing computer executable code (i.e., software) can implement the functions described herein using one or more of a combination of popular computer programming languages and developing environments including, but not limited to, C, C++, Visual Basic, JAVA, HTML, XML, ACTIVE SERVER PAGES, JAVA server pages, servlets, and a plurality web site development applications.

Although the present invention is described by way of example herein and in terms of a web-based system using web browsers and a web site server (e.g., site processor 4), system 2 is not limited to such a configuration. It is contemplated that system 2 is arranged such that a user terminal communicates with and displays data received from site processor 4 using any known communication and display method, for example, using a non-Internet browser WINDOWS viewer coupled with a local area network protocol such as the Internet Packet Exchange (IPX), dial-up, third-party, private network or a value added network (VAN).

It is further contemplated that any suitable operating system can be used on site processor 4 and a user terminal, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS, POCKET PC and any other suitable operating system.

As used herein, references to displaying data on site processor 4 and a user terminal regard the process of communicating data across communication network 10, and processing the data such that the data are viewed on a display, for example by using a web browser and the like. As is common with web browsing software, the display on a user terminal presents sites within system 2 such that a user can proceed from site to site within the system by selecting a desired link.

Therefore, each user's experience with system 2 is based on the order with which he/she progresses through the display screens. Graphic controls are preferably available in the display screens and modules to initiate data processes, and to provide convenient navigation between the display screens and modules of system 2. In other words, because the system is not completely hierarchical in its arrangement of display screens, users can proceed from area to area without the need to “backtrack” through a series of display screens. For that reason, and unless explicitly stated otherwise, the following discussion is not intended to represent any sequential operation steps, but rather to illustrate the components of system 2.

As used herein, the term, “module,” refers, generally, to one or more discrete components that contribute to the effectiveness of the present invention. Modules can operate with, or depend upon, one or more other modules in order to function and contribute to the functionality of the present invention and described herein.

The present invention enables parties to transmit electronic materials 12 securely, and to track and monitor the transmissions. As used herein, electronic material 12 can include at least one of a ADOBE PDF document, spreadsheet, database file, document, image file, sound file, digital motion picture file, or any other electronic source capable of being transmitted over a communication network.

The accompanying drawing figures make several references to PDF files that are used for distribution via the present invention. References to PDF in the drawing figures is meant for purposes of illustration and example only, and is not meant to limit or restrict the scope of the invention to PDF files. Any electronic document that is capable of being transmitted is envisioned herein, including, for example, sound files, audio files, image files, documents, spreadsheets, databases and the like. Since PDFs are a commonly used format for electronic documents that are distributed over the Internet, PDFs are used in the various examples set forth herein.

Also as used herein, an e-mail project 11 refers, generally, to a single distribution of at least one message having a hyperlink or the like to electronic material 12 provided on site processor 4, and distributed to one or more recipients 6. As used herein, the term, registered user 8, refers, generally, to a person or company that is authorized to operate the present invention, in part, to distribute and track electronic materials 12, to define lists of e-mail recipients 6 and to manage other registered users 8. Registered users 8 are considered distinct from e-mail recipients 6, who are typically only authorized to receive and review electronic materials 12 distributed by registered user 8. One skilled in the art will recognize that registered users 8 can also function as e-mail recipients 6.

E-mail recipient 6 preferably selects the hyperlink in the body of an e-mail message 14 to establish a secure session with site processor 4, and to receive the respective electronic material.

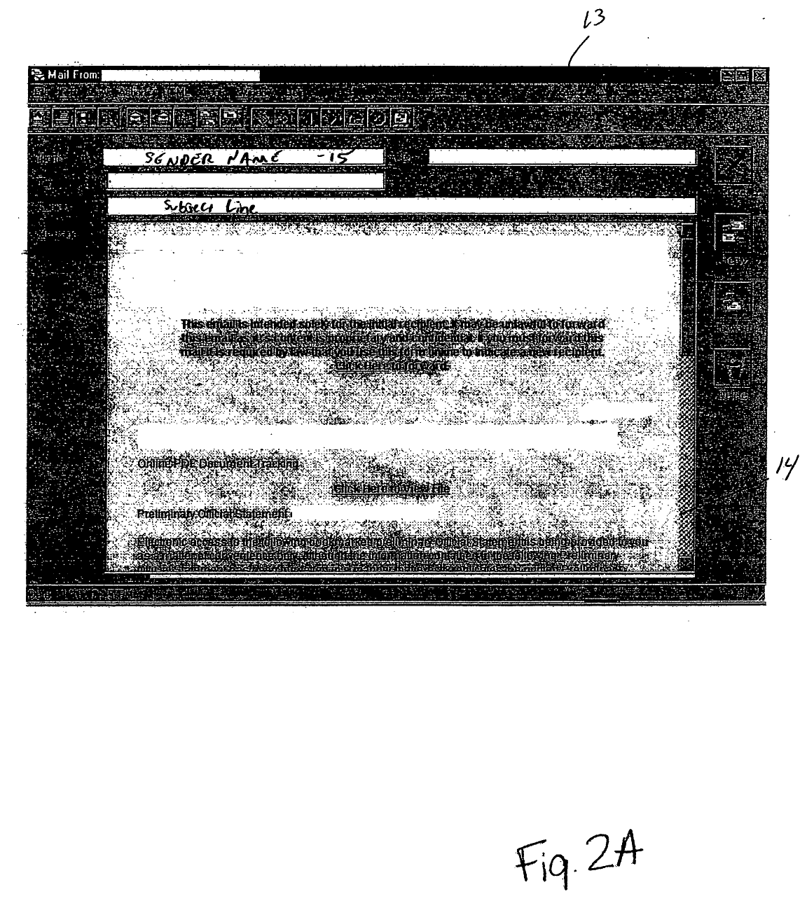

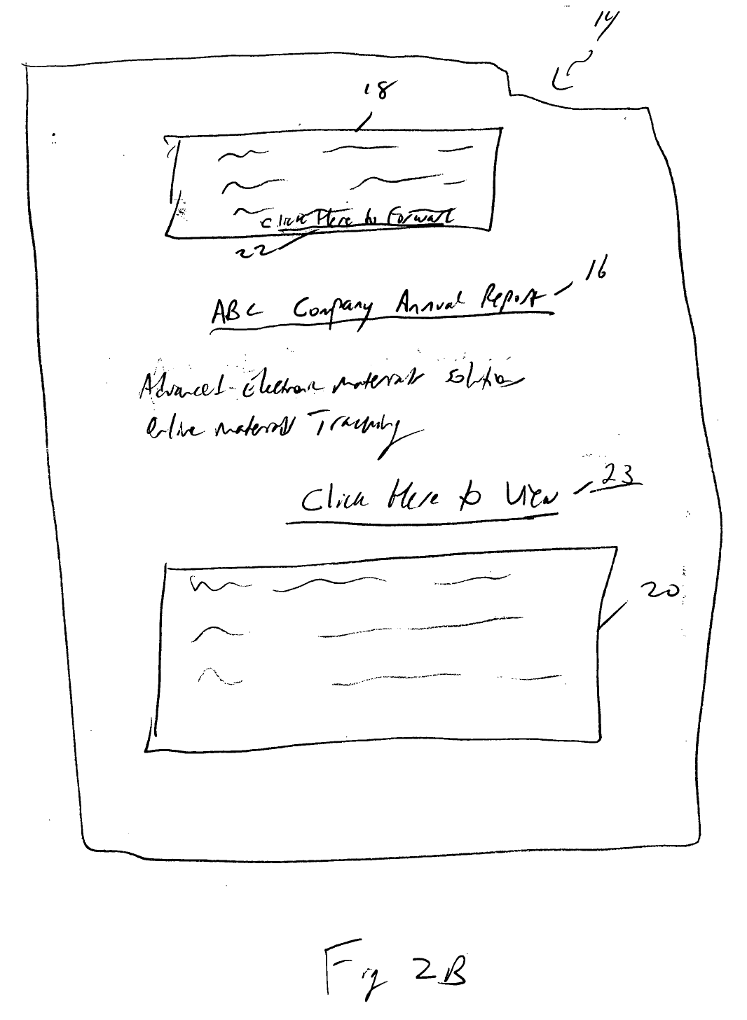

In accordance with an example embodiment of the present invention, an e-mail recipient 6 is preferably notified in message 14 that electronic material 12 is available by selecting the hyperlink. In an example embodiment, and substantially as shown in FIGS. 2A and 2B, recipient 6 receives an e-mail message 14, for example, in e-mail client software 13, and is notified of sender's name 15, name of the electronic material 12 and any descriptive information provided by the sender. Preferably, e-mail recipient 6 selects hyperlink 16 to access electronic material 12. Moreover, e-mail message 14 preferably includes disclaimer 18 that electronic material 12 is potentially proprietary and confidential and is intended solely for that recipient 6, and that it may be unlawful to forward the e-mail message 14 to other recipients. As shown in FIG. 2B, hyperlink 22 is preferably included in e-mail message 14 that enables e-mail recipient 6 to forward e-mail message 14 to another recipient 6.

E-mail message 14 also can include Preliminary Official Statement section 20 which includes a disclaimer and a Preliminary Official Statement hyperlink 23 to access the Preliminary Official Statement. For example, e-mail message 14 states that electronic access to a Preliminary Official Statement is provided as a matter of convenience. The Preliminary Official Statement disclaimer may state that the information contained in the Preliminary Official Statement is formatted in a manner to replicate the printed version of the Preliminary Official Statement, however the physical appearance of the Statement may differ for various reasons, including electronic communication difficulties or particular user equipment. Users are preferably recommended to obtain a copy of a printed version of the Preliminary Official Statement for reference. The Preliminary Official Statement disclaimer may further state that the user of the electronic version assumes the risk of any discrepancies between the printed Preliminary Official Statement and the electronic version. The Preliminary Official Statement disclaimer can also state that, by clicking on hyperlink 23, the user agrees to the terms and conditions set forth.

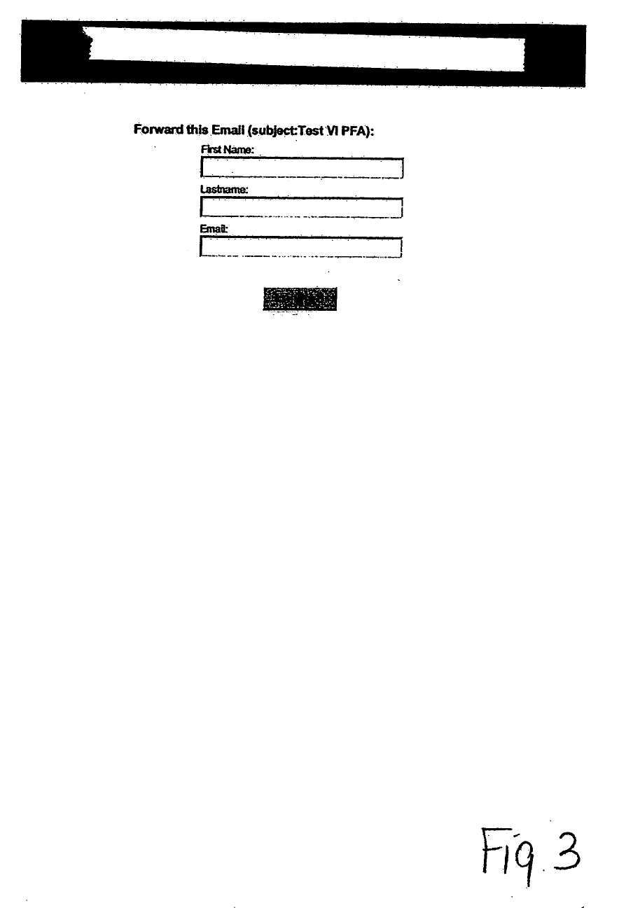

FIG. 3 shows an example web page that is available to e-mail recipients 6 who select hyperlink 22 in disclaimer 18 in order to forward e-mail message 14. The present invention preferably provides tracking information of recipients of forwarded e-mail messages 14, and can provide the e-mail addresses thereof to registered user 8 who developed e-mail project 11.

In accordance with an example embodiment of the present invention, and unlike prior art methods of simply attaching electronic materials to e-mail messages, electronic material 12 that is intended for e-mail recipients 6 is not transmitted to recipients 6 with electronic message 14. Instead, recipients 6 are e-mailed message 14 that includes a hyperlink to an Internet web site on site processor 4 that preferably provides secure access to electronic material 12. By selecting the hyperlink and providing proper authorization, e-mail recipient 6 establishes a secure on-line session with site processor 4, and any actions taken by recipient 6 during the session, for example, with respect to electronic material 12, can be tracked and reported.

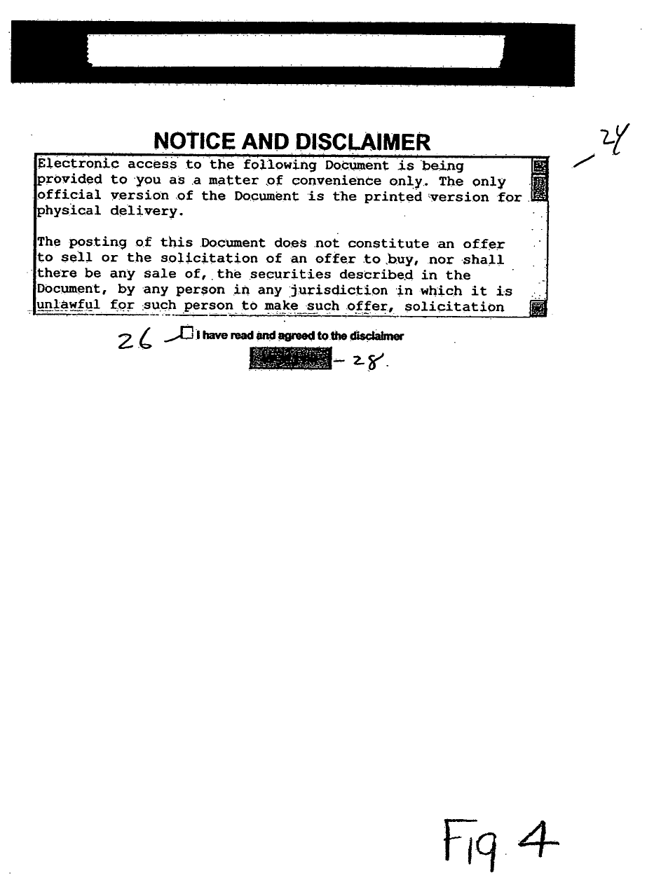

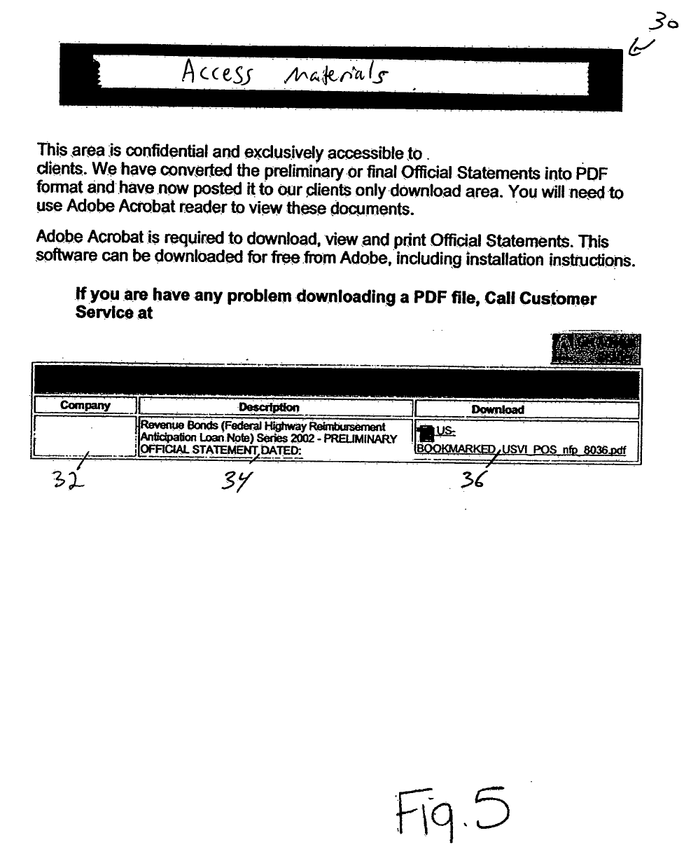

During an active and secure session with site processor 4, e-mail recipient 6 is preferably presented with a notice and disclaimer that identifies legal restrictions with respect to electronic materials 12 (FIG. 4). E-mail recipient 6 is prompted to indicate that (s)he has read and agreed to the disclaimer materials, and, thereafter, selects graphic control, for example, check box 26, in order to access electronic materials 12. After selecting check box 26, e-mail recipient 6 selects view file button 28 and is preferably presented with access materials display screen 30 that identifies the name of electronic materials 12 (FIG. 5), company name 32 and any descriptive information 34, for example, a description of the electronic materials, registered user 8 previously elected to include therewith. Access materials display screen 30 further includes hyperlink 36 that, when selected, enables electronic materials 12 to be downloaded to the user terminal operated by e-mail recipient 6. E-mail recipient 6 is then able to access electronic materials 12.

In this way, a sender of electronic materials 12 can ensure that recipients 6 establish secure sessions with site processor 4 in order to receive the materials. A senders is assured control over the distribution and reception of electronic materials 12, and, further, of effective and accurate tracking thereof.

Preferably, the present invention supports varying levels of access to functionality that is available for different types of registered users 8. For example, a registered user 8 may be classified as a system administrator who is authorized to add new registered users 8. Also, a system administrator can assign authorization privileges for other users 8, for example, that include the ability to define e-mail lists and to transmit electronic materials 12 in accordance with an example embodiment of the present invention. Other functions available for a system administrator include the ability to view electronic materials tracking information, to manage users or the like.

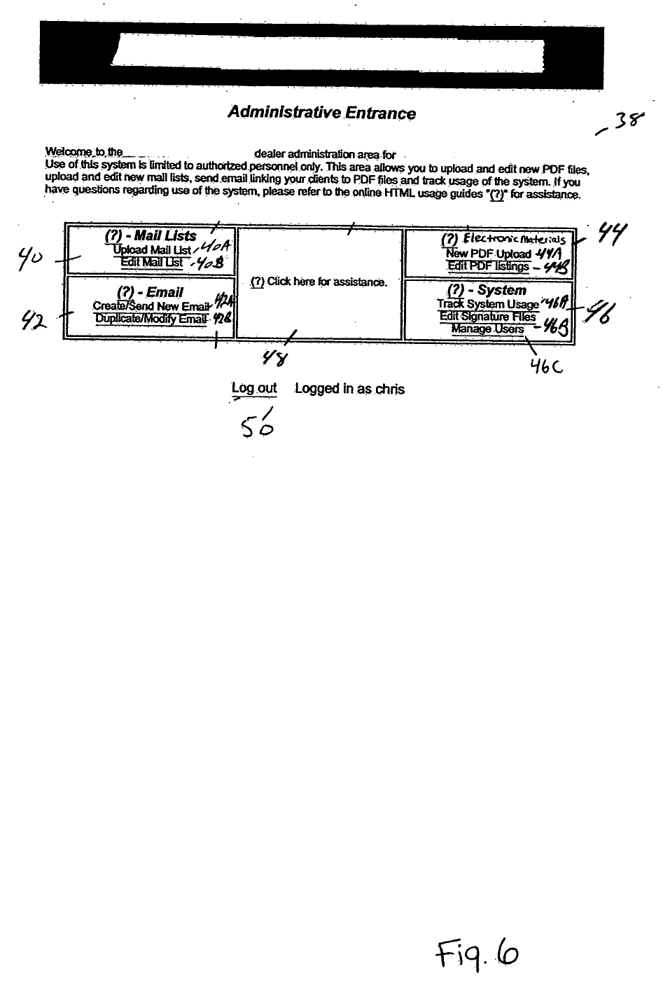

FIG. 6 shows an administrative entrance display screen 38 provided to a registered user 8 who desires to distribute electronic materials to one or more e-mail recipients 6. Included in FIG. 6 are selections available to a registered user 8 in the form of hyperlinks in display screen 38. For example, registered user 8 uses the functionality of the present invention via mail list section 40, e-mail message section 42, electronic materials section 44 and system management 46. On-line help is preferably available via help portion 48. As shown in FIG. 6, a registered user, Chris, is “logged in” to the site web site provided by site processor 4. For example, Chris has supplied a valid user name and password to gain access to administrative entrance display screen 38. Log-out hyperlink 50 enables registered user 8 to terminate an on-line session with site processor 4. As shown in the drawing figures, log-out hyperlink 50 is frequently provided in the display screens of the present invention to enable a registered user 6 to terminate a secure session with site processor 4 conveniently. Thus, registered user 8 is afforded access to much of the functionality described herein.

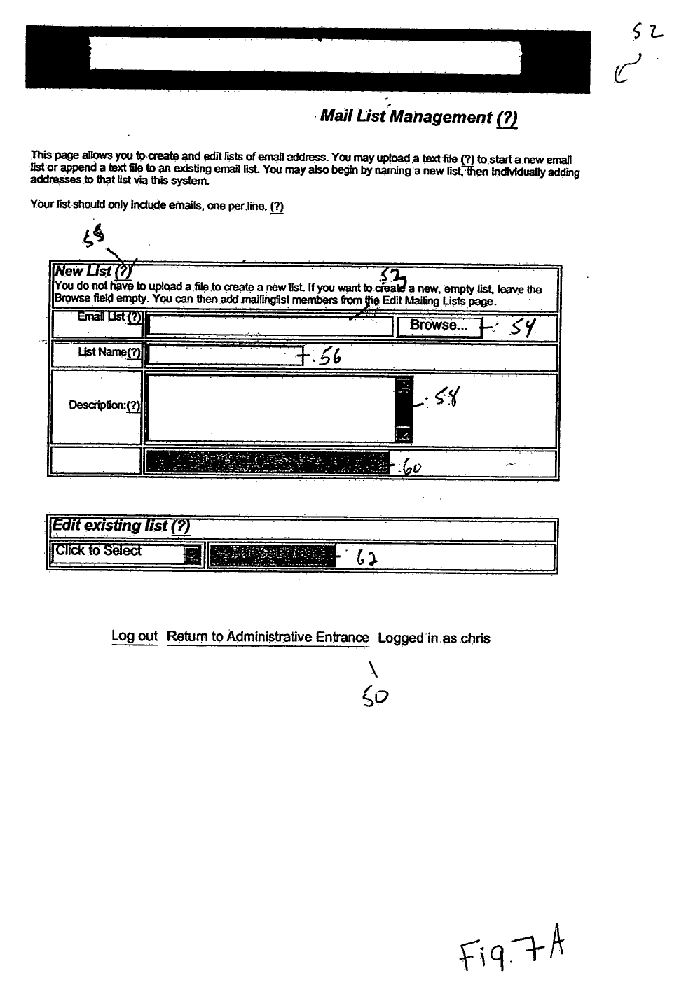

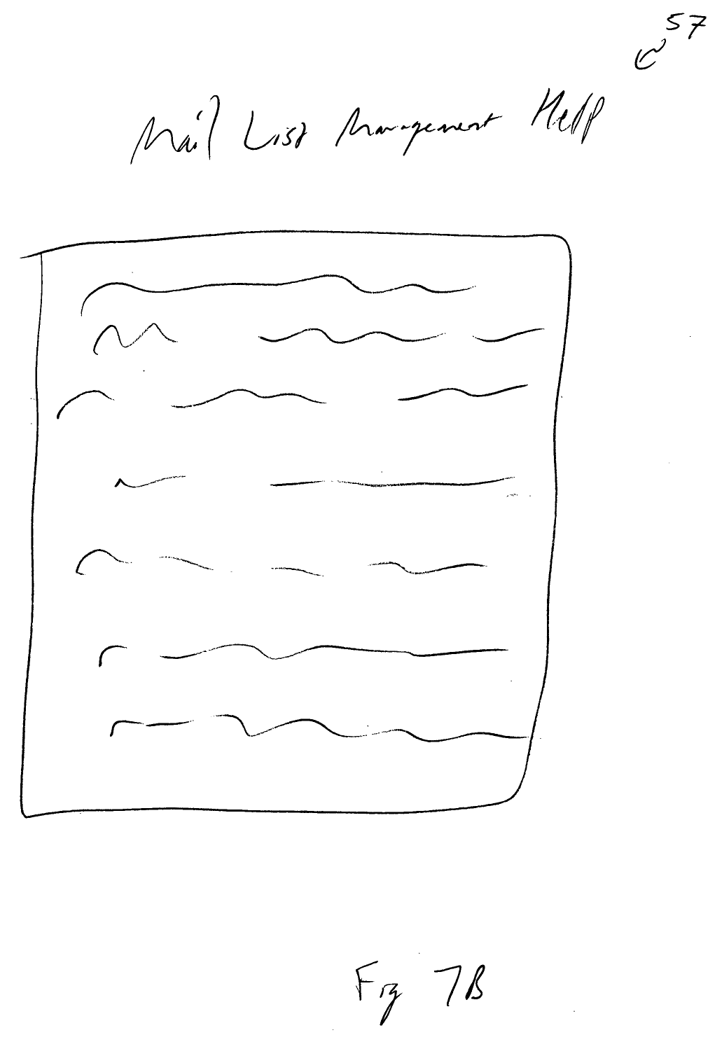

FIG. 7A shows an example mail list management display screen 52 that is presented to registered user 8 who selects upload mail list hyperlink 40A or edit mail list hyperlink 40B from mail list section 40 (FIG. 6).

In an example embodiment of the present invention, registered users 8 define e-mail recipient lists that contain e-mail addresses of recipients 6 and stored on registered user's 8 user terminal. The lists are preferably formatted, for example, as spreadsheets or ASCII delimited text files, and are transmitted to site processor 4. Registered users 8 preferably use a formatting specification, such as a specific record definition provided by site processor 4. The e-mail list file is uploaded to site processor 4, via the present invention, and used to identify recipients for e-mail messages 14 having hyperlinks to electronic materials 12. Alternatively, a new e-mail list is defined by entering information regarding recipients 6 in a data entry display screen provided by site processor 4. For example, a registered user 8 leaves the name in e-mail list text box 53 blank, and then selects edit existing list 62 to add new recipients in a list.

In an example embodiment of the present invention, after an e-mail list file is created on a registered user's computer, registered user 8 identifies (e.g., “navigates”) to the particular location of the file on registered user's computer system, for example, by clicking browse button 54 and by selecting the particular folder where the e-mail list file exists. Thereafter, registered user 8 identifies the e-mail list with a name (via text box 56), and further provides a brief description of the list (via text box 58). After registered user 8 is satisfied with the information provided in the display screen, as shown in FIG. 7A, he adds the list, for example, by selecting add new address list now button 60. In the event that the list needs to be modified, for example, because a name or address has to be added, changed or removed, then registered user 8 preferably selects edit existing list button 62 in order to make modifications to an existing list.

In an example embodiment, the present invention verifies the e-mail addresses in a recipient list. For example, each e-mail address is analyzed to ensure compliance with formatting rules, such as a root name, an “@” character and a domain. Also an e-mail test message may be transmitted to one or more e-mail addresses in an e-mail list. If an invalid e-mail address is identified, the present invention preferably compiles a list of invalid e-mail addresses and notifies registered user 8, for example, by e-mail, that at least one invalid e-mail address has been discovered and a list of the invalid e-mail addresses is preferably provided.

FIG. 7B shows an example mail list management help display screen 57 that is provided to a user who clicks on mail list help hyperlink 55 (FIG. 7A). As represented in FIG. 7B, information is provided to registered user 8 for help with defining a mail list in accordance with an example embodiment of the present invention. For example, the example mail list management help display screen explains that users can create and manage e-mail address lists for use with the present invention. Users are suggested to upload an electronic file, such as an ASCII delimited text file, to create e-mail lists from existing data, or create a named e-mail list and enter names manually into system 2. The help display screen 57 also preferably explains that users can create new mail lists or edit existing mail lists individually by e-mail address. Preferably, the e-mail list management help display screen includes ways to create new mail lists by either uploading an electronic file containing the list information, or creating an unpopulated mail list and then having recipients individually via display screen 52.

Information is also provided in display screen 57 that explains that e-mail lists can contain e-mail addresses and any other information desired by a user. Information in e-mail lists can be managed and tracked online. Further, mail list management help display screen 57 explains that graphic screen controls, such as drop down lists, can be used to identify a specific e-mail list to be edited, such as adding new members. Also, mail list management help display screen 57 preferably identifies that e-mail verification will be performed on each e-mail address, such as for identifying duplicate e-mail addresses that are in the list, improper e-mail formatting, and whether the e-mail address is functional. Any e-mail addresses that fail the above-identified tests, are preferably removed from the list, and the mail list management help display screen 57 preferably includes a statement to this effect.

In addition to developing and managing e-mail lists, registered users 8 create and send new e-mail messages 14 using the present invention. As shown in FIG. 6, registered user 8 uses e-mail section 42 and selects, for example, create/send new e-mail hyperlink 42A or duplicate/modify e-mail hyperlink 42B in order to create new and/or edit existing e-mail messages 14 for recipients 6.

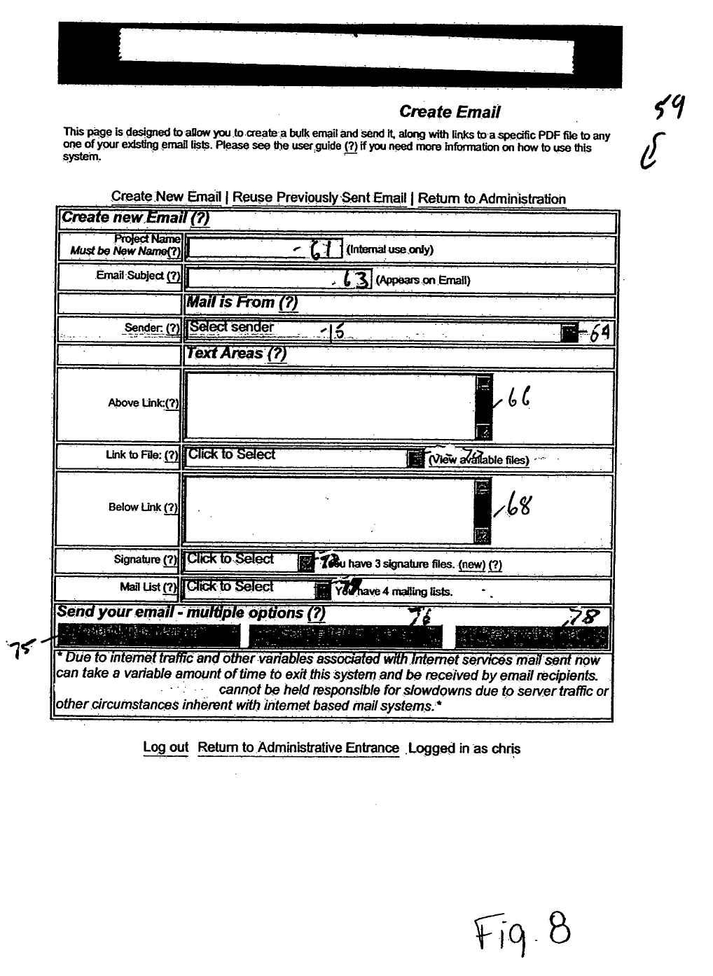

FIG. 8 shows create e-mail display screen 59 that is preferably presented to registered user 8 after create/send new e-mail hyperlink is selected from e-mail section 42 (FIG. 6). Included are controls for project name 61, e-mail subject name 63, and sender name 15. In an example embodiment and as shown in FIG. 8, a list of senders names 15 are available via drop-down control list 64 for ease of use. After registered user 8 has provided sender name 15 and/or subject line 63 of the e-mail message, registered user 8 provides text 66, 68 that regards language to be applied before and after a hyperlink, respectively, that provides access to electronic materials 12.

Continuing with reference to FIG. 8, registered user 8 preferably selects link to file drop-down list 70 to identify the electronic material 12 to be distributed. Registered user 8 selects signature drop-down list 72 and mail list drop-down list 74 in order to provide an electronic signature and designated recipient mailing lists, respectively. After registered user 8 is satisfied with the selections entered in display screen 59, (s)he either transmits the mail immediately (by clicking send this mail now button 75), sends the e-mail message into a cue for future delivery (send e-mail to queue button 76) or previews the e-mail (via preview button 78) to ensure that the layout and information therein is correct.

In addition to mail lists and e-mail messages, the present invention enables a registered user 8 to manage electronic materials 12 to be distributed, for example by selecting new upload hyperlink 44A or edit listings hyperlink 44B. Additional functionality directed to electronic materials 12 is provided.

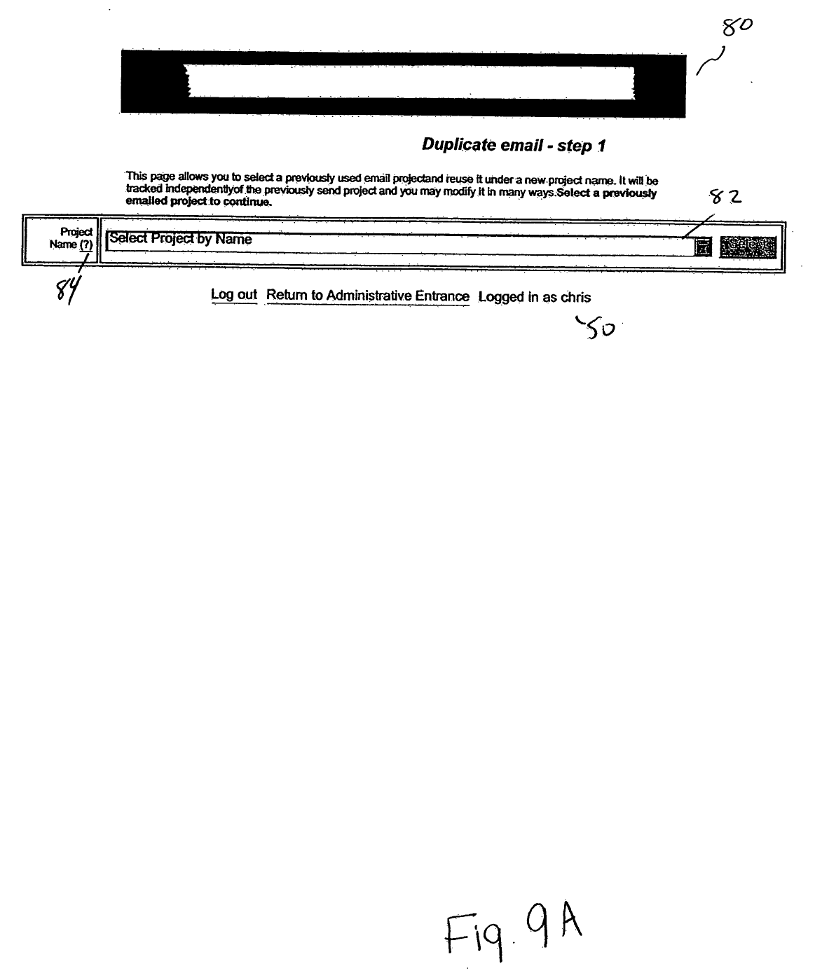

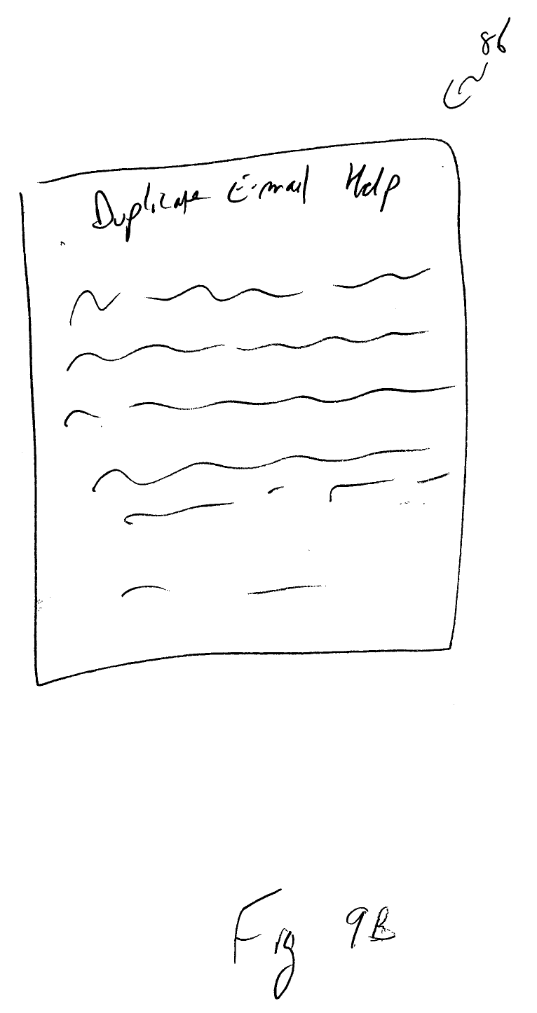

In addition to creating and sending new e-mail messages 14, the present invention allows registered users 8 to select a previously used e-mail project 11 and duplicate it for reuse it with a new project name (FIG. 9A). For example, fifty recipients 6 may have previously been sent electronic material 12, such as a proxy statement. Three weeks later, the same fifty recipients are scheduled to receive a prospectus. Rather than creating a new e-mail project 11 and redefining, for example, all fifty recipients 6, new text information, hyperlink to the electronic resource, signature and mail list files, the present invention affords a convenient interface to select an existing project 11 by name, and to re-use it for future distribution.

FIG. 9A shows an example duplicate e-mail display screen 80 used for duplicating a previously used e-mail project 11. As shown in FIG. 9A, registered user 8 identifies project 11 to be duplicated via select project by name drop-down list 82, and then selects project 11 by clicking a button, for example, labeled “Select.”

FIG. 9B shows an example duplicate e-mail project help display screen 86 that is provided to a user who selects project name help hyperlink 84. Preferably, instructional information regarding duplicating e-mail projects 11 is provided in display screen 86. For example, display screen 86 indicates that e-mail message 14 has been saved under a current project name, and if the name is not changed, then the original project will be overwritten with the new information. If a user desires to save a new e-mail project separate from the original, then the user is instructed to assign a new project name, and the original e-mail project will maintain its original information.

Also preferably included in duplicate e-mail project help display screen 86 is information directed to the contents of duplicate e-mail display screen 80. For example, display screen 86 alerts registered user 8 that information contained in duplicate e-mail display screen 80 can be edited, re-sent or saved. When registered user 8 edits the name of e-mail project 11 via duplicate e-mail display screen 80, a new e-mail project 11 will be created. Alternatively, if a new project name is not assigned, then the previous e-mail project 11 will be overwritten with the information contained in duplicate e-mail display screen 80. A warning is preferably provided that this may negatively impact those who have received a previously sent e-mail and have not yet responded by, for example, selecting hyperlink 16 in e-mail message 14 (FIG. 2B).

Further, duplicate e-mail project help display screen 86 preferably identifies terms that are provided in duplicate e-mail display screen 80. For example, help screen 86 provides information that a duplicate e-mail project 11 can have the same sender name 15 as provided in the e-mail project 11 that was duplicated, or registered user 8 can change the name of the sender. Further, help screen 86 identifies that HTML formatting is available in order to enhance the appearance and functionality of e-mail message 14. Registered user 8 is also instructed to choose among options for sending e-mail project 11, placing e-mail project 11 in a queue in accordance with a time stamp, or to preview the e-mail project. The first choice, sending the e-mail, allows registered user 8 to immediately run through a queue of e-mail as it is being sent. In this way, users are informed that e-mail message 14 has been transmitted. The second choice, send e-mail to queue, allows registered user 8 to select and hold e-mail message 14 in a queue which will then go out during, for example, the next mail send timed queue operation (e.g., in fifteen minutes). In this way, registered user 8 can terminate the on-line session with site processor 4 and remain assured that e-mail project 11 will be transmitted. The third choice, preview this mail, allows registered user 8 to review e-mail message 14 before sending it. Thus, the duplicate e-mail help display screen 86 provides instructional information regarding duplicating e-mail projects 11.

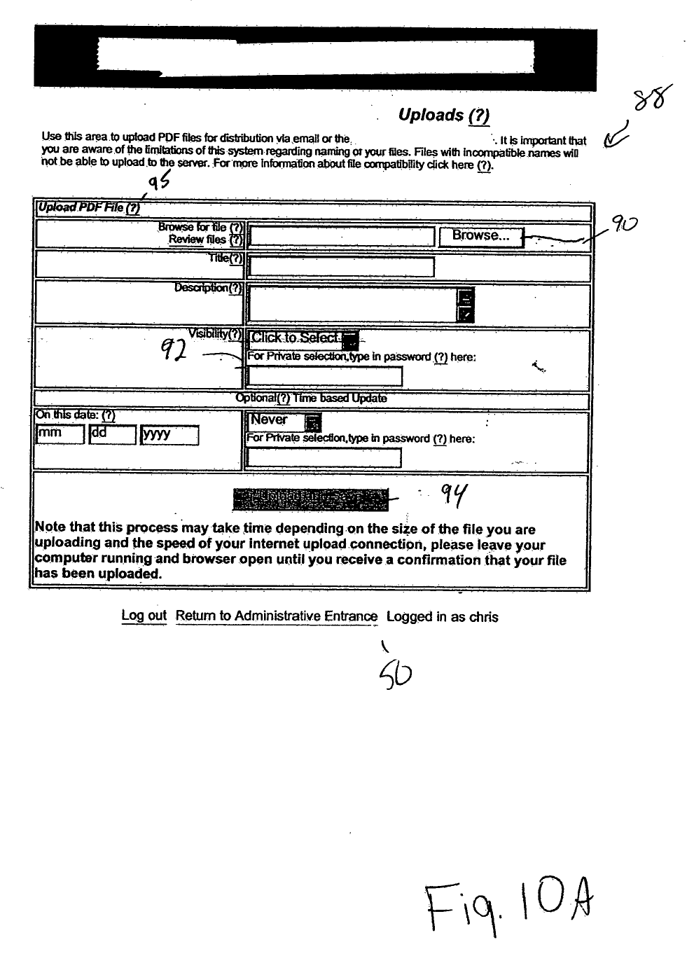

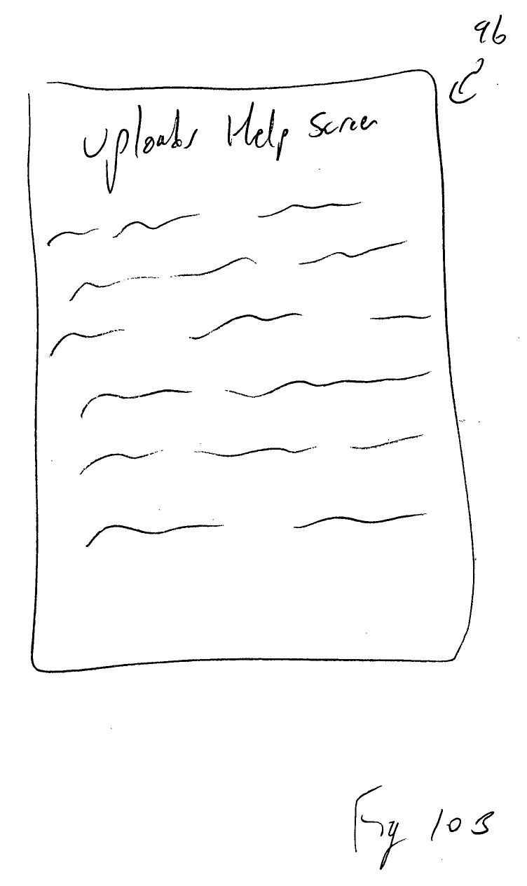

After registered user 8 selects new upload hyperlink 44A from electronic materials section 44 (FIG. 6), an electronic materials upload display screen 88 is presented, as shown in FIG. 10A. The example display screen shown in FIG. 10A represents an interface for registered user 8 to upload electronic materials, for example, a PDF, to site processor 4 for eventual distribution to e-mail recipients 6. As shown in FIG. 10A, registered user 8 selects a control for browsing directory and/or folder structure of registered user's 8 computer system. For example, browse button 90 enables a user 8 to identify a particular electronic material to be uploaded to site processor 4. After electronic material 12 has been identified, registered user 8 preferably provides a short title and brief description of the material 12, and further, in visibility portion 92, identifies whether or not the electronic material 12 should be designated private, such as by making the record visible to a recipient with a password. In an example embodiment of the present invention, registered user 8 can also identify a specific date that a document becomes either visible to the general public, becomes public, private or deleted. After registered user 8 is satisfied with the selections made, for example, shown in example display screen 88, registered user 8 preferably uploads and saves the electronic material 12 to site processor 4, for example, by selecting upload and save button 94. The electronic material 12 is uploaded, for example, via a POST function.

In an alternative embodiment, a JAVA applet is transmitted to and runs on the registered user's 8 user terminal that provides a file transfer protocol (“FTP”) client. As known in typical FTP client software, the registered user 8 is presented with a display screen that enables navigation of a directory structure of the registered user's user terminal to identify and select the electronic material 12 to be uploaded to site processor 4. Preferably, the directory structure of site processor 4 is hidden from the registered user's view. In this, the contents of site processor 4 are preferably kept private from registered users 8.

FIG. 10B shows an example upload help display screen 96 that is provided to a user who selects help hyperlink 95. Upload help display screen 96 preferably includes information directed to instructing registered user 8 for uploading electronic documents via system 2. For example, display screen 96 includes information that registered user 8 can send electronic files from his/her individual computer systems, or from locations on a network for distribution and tracking via system 2. Registered users 8 are preferably instructed to assign a name, a description, a visibility preference and an optional time to update the file's visibility setting. Further, help screen 96 preferably explains controls in FIG. 10A, such as browse button 90 that provides a display screen for enabling a registered user 8 to navigate to a particular folder or directory where electronic material 12 resides. Further, registered user 8 is alerted to a feature for reviewing the electronic material 12 that is uploaded to site processor 4, for example, to ensure the material is correct. Also, registered user 8 is preferably warned in display screen 96 that upload and save button 94 (FIG. 9A) overwrites a previously sent file having the same name. Also, the “visibility” tag enables the user to identify for whom the file is to be visible. More particularly, e-mail recipients 6 who do not have a hyperlink to the electronic material 12 will not be able to review the file. Effectively, the file is invisible to those users.

Further, help screen 96 identifies that private electronic materials 12 require a password before an e-mail recipient 6 is entitled to review the material. Public materials, in contrast, are visible on public lists of files that are visible to all visitors of the web site provided by site processor 4. Further, help screen 96 identifies that users are allowed, via system 2, to define in advance a date that they would like file visibility to change. Thus, the example upload help display screen 96 provides instructional information for users desiring to provide electronic materials 12 via the present invention.

In addition to uploading a new electronic material to site processor 4 for distribution to e-mail addresses in an e-mail list, the present invention preferably enables registered user 8 to associate and edit properties for electronic materials 12, for example, by selecting edit listing hyperlink 44B, shown in FIG. 6.

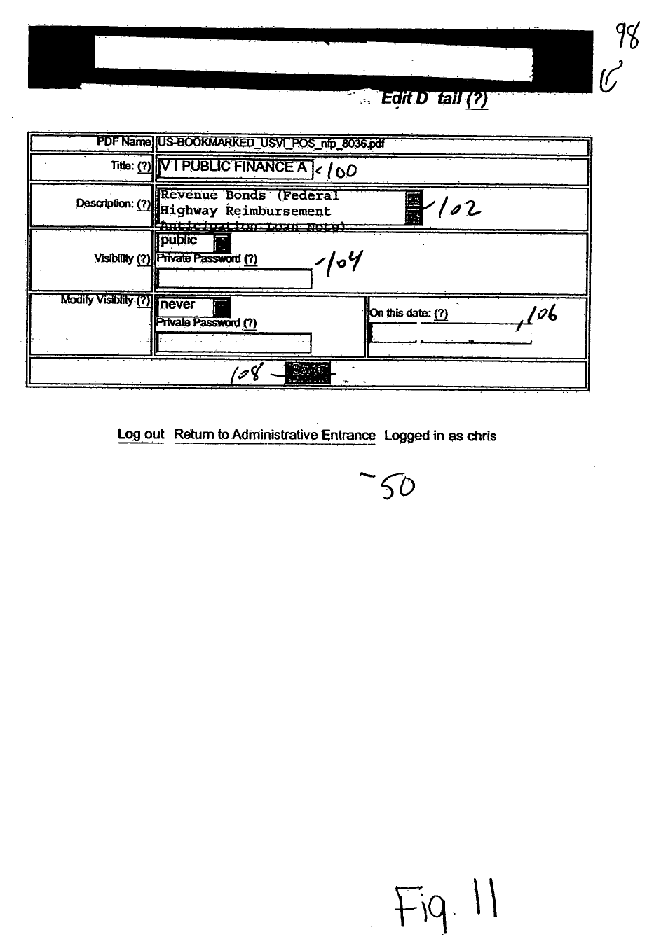

FIG. 11 shows an example edit detail display screen 98 for editing properties directed to electronic materials 12 in accordance with an example embodiment of the present invention. In the example shown in FIG. 11, a PDF document has been selected that has properties previously assigned thereto, including a descriptive title of “V I PUBLIC FINANCE A,” a classification as “public” and “visible” to recipients 6. Registered user 8 uses the controls shown in the example display screen shown in FIG. 11 to modify any of these details including, for example, via title 100, description 102, visibility rules 104, and date activities associated with electronic material 106. After registered user 8 is satisfied with the selections made in display screen 98, registered user 8 saves the changes, for example, by clicking save button 108. Thereafter, registered user 8 is provided administrative entrance display screen 38 as shown in FIG. 6.

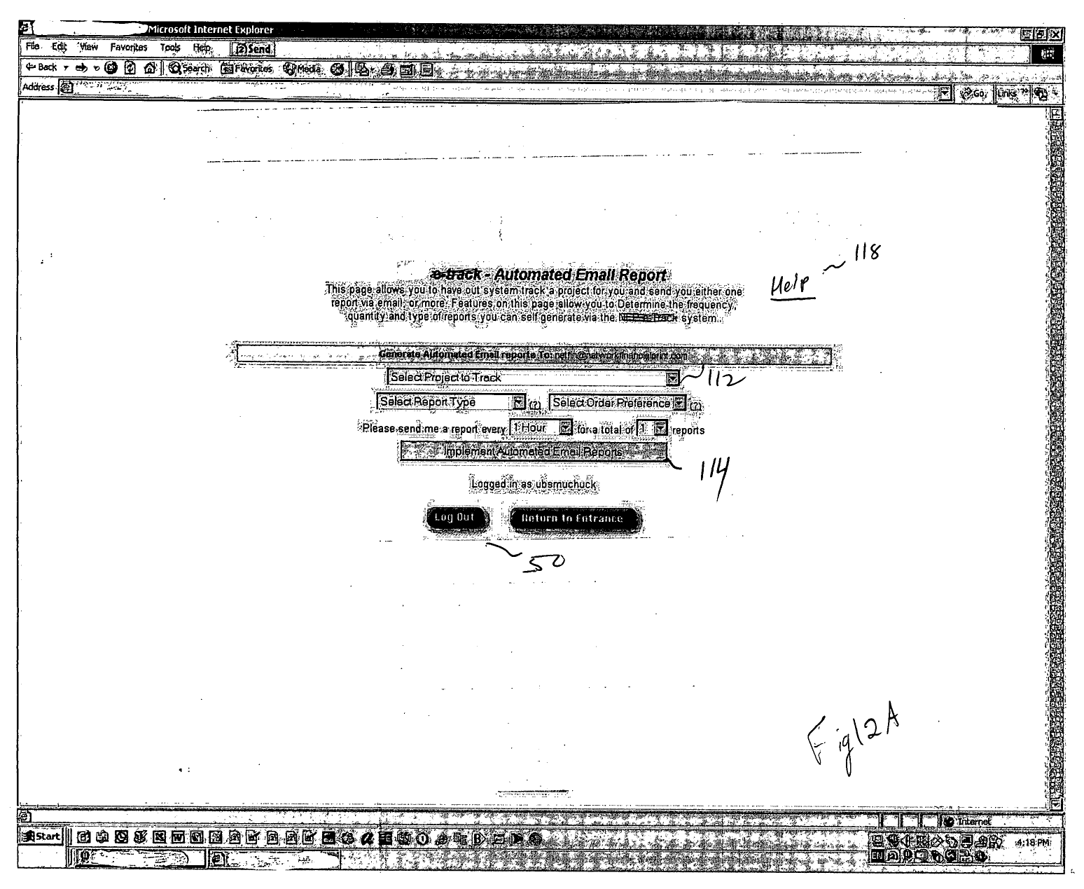

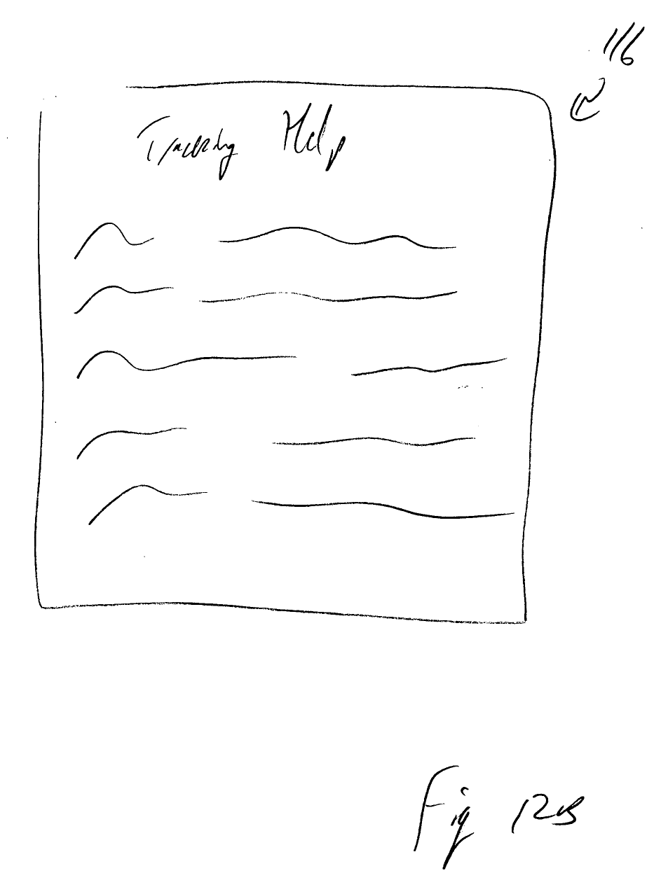

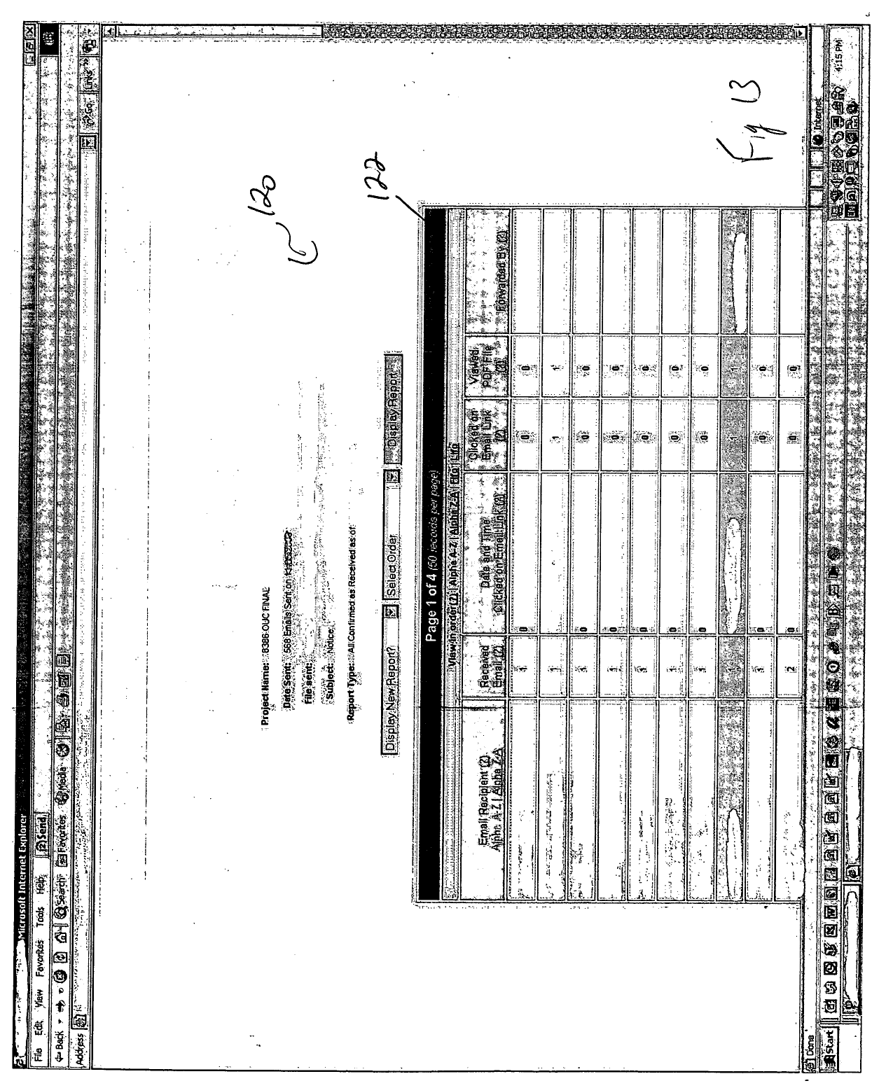

Other choices provided in administrative entrance display screen 38 include track system usage hyperlink 46A, edit signature files hyperlink 46B and manage users hyperlink 46C, as shown in system section 18 (FIG. 6). After registered user 8 selects track system usage from administrative entrance display screen 38, registered user 8 is provided display screens substantially as shown in FIGS. 12A and 13A.

As shown in FIG. 12A, registered user 8 is provided track usage display screen 110 for selecting an e-mail project 11, for example, from drop-down list 112 which lists projects 11 that have been provided by a registered user 8. After registered user 8 is satisfied with the name of project 11 that is displayed in drop-down list 112, then registered user 8 preferably selects project 11, for example, by selecting select button 114.

FIG. 12B shows an example tracking help display screen 116 that is provided to a user who selects help hyperlink 118 (FIG. 12A). Preferably, tracking help display screen 116 defines terms for a registered user 8. For example, help display screen 116 identifies the terms and features of system 2, substantially as described above. Thus, in example display screen 116, instructional information is provided that defines and explains terms shown in FIG. 12A.

FIG. 13 shows an example tracking display screen 120 for reviewing tracking information regarding e-mail projects 11. As shown in FIG. 13, registered user 8 is provided table 122 that identifies tracking information for distributed electronic materials 12. As noted above, electronic materials 12 are not simply attached to e-mail messages 14 and transmitted to recipients 6, as in the prior art. Since electronic materials 12 are not attached to e-mail messages and transmitted directly to e-mail recipients 6, an e-mail recipient's actions with respect to electronic materials 12 can be tracked. For example, once e-mail recipient 6 selects the hyperlink that is included in the body of e-mail message 14, the present invention preferably makes an entry in a database that e-mail recipient 6 selected the hyperlink in the body of e-mail message 14 that was transmitted. The present invention preferably uses the data to provide registered user 8 with tracking details directed to e-mail message 14 and associated electronic material 12. For example, as shown in FIG. 13, registered user 8 is presented with table 122 that identifies that an e-mail recipient 6 received an e-mail, the date that the hyperlink to electronic materials 12 was selected, whether e-mail recipient 6 agreed to disclaimer language presented to the e-mail recipient prior to accessing electronic materials 12, whether or not the electronic materials were actually accessed and whether e-mail message 14 comprising the hyperlink for accessing the electronic materials was forwarded to another recipient 6. In an example embodiment, e-mail recipient 6 cannot access electronic materials via the present invention without indicating the disclaimer language has been read.

After registered user 8 reviews the information displayed in the example display screen shown in FIG. 13, registered user 8 is provided administrative entrance display screen 38 (FIG. 6). In addition to tracking system usage (hyperlink 46A), registered user 8 can select create and edit signature files hyperlink 46B to append a signature to the end of e-mail message 14.

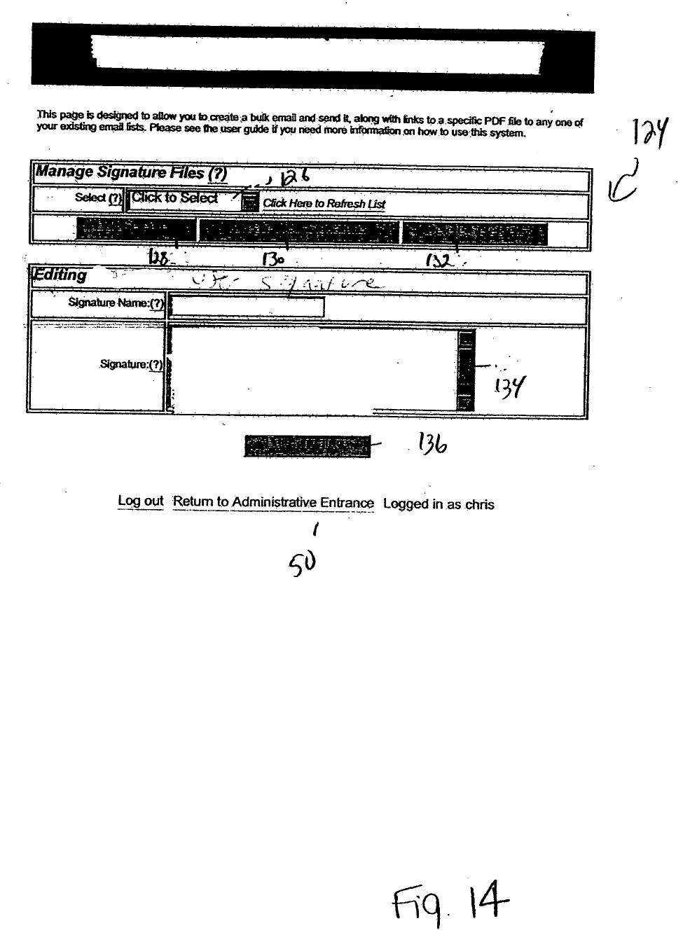

FIG. 14 shows an example manage signature files display screen 124 presented to registered user 8 after edit signature files hyperlink 46B was selected from system section 46 (FIG. 6). As shown in FIG. 14, registered user 8 selects a signature file stored on site processor 4, for example, by selecting drop-down list 126. After a signature file is selected, registered user 8 edits the signature file, for example, by selecting edit selected button 128. In the event that no signature file is stored on site processor 4, or registered user 8 desires to add a new signature file, registered user 8 can select, for example, create new signature button 130 to add a new signature file. Registered user 8 deletes a selected signature file, for example, by selecting delete selected button 132. After a signature file is selected, for example, to be edited or deleted, the details of the signature file are presented in signature file text area 134. Modifications can be made to a signature via signature text area 134 and then saved to site processor 4, for example, by selecting edit signature button 136. Registered users 8 are preferably able to add new signature files in substantially the same way, for example, by providing a new signature name and new signature text in text area 134. Thereafter, registered user 8 saves the new signature file on site processor 4 for future use.

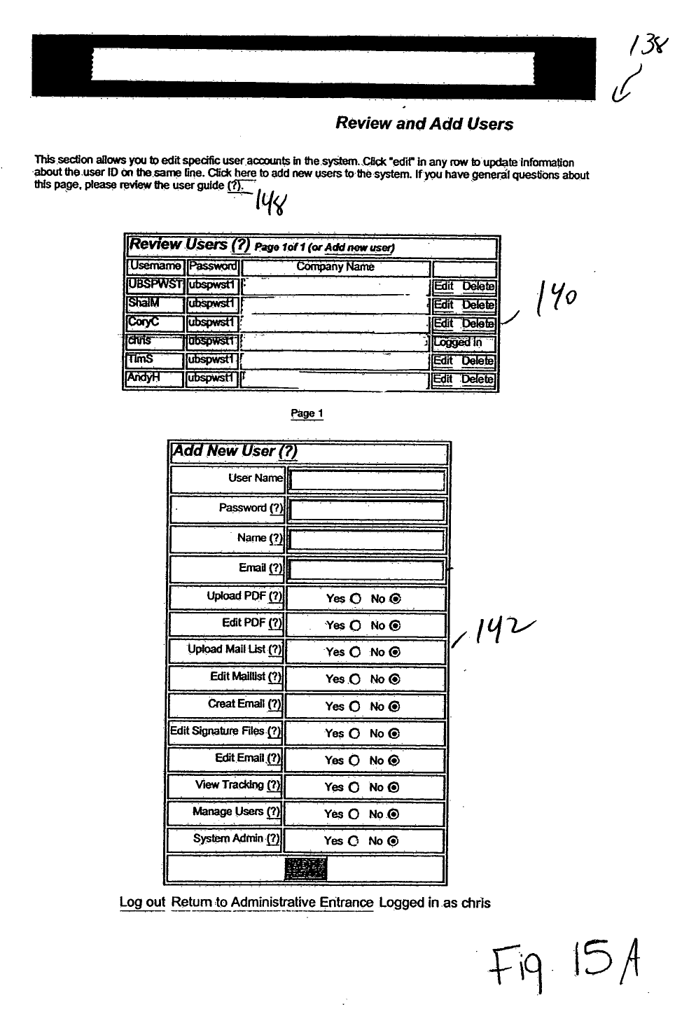

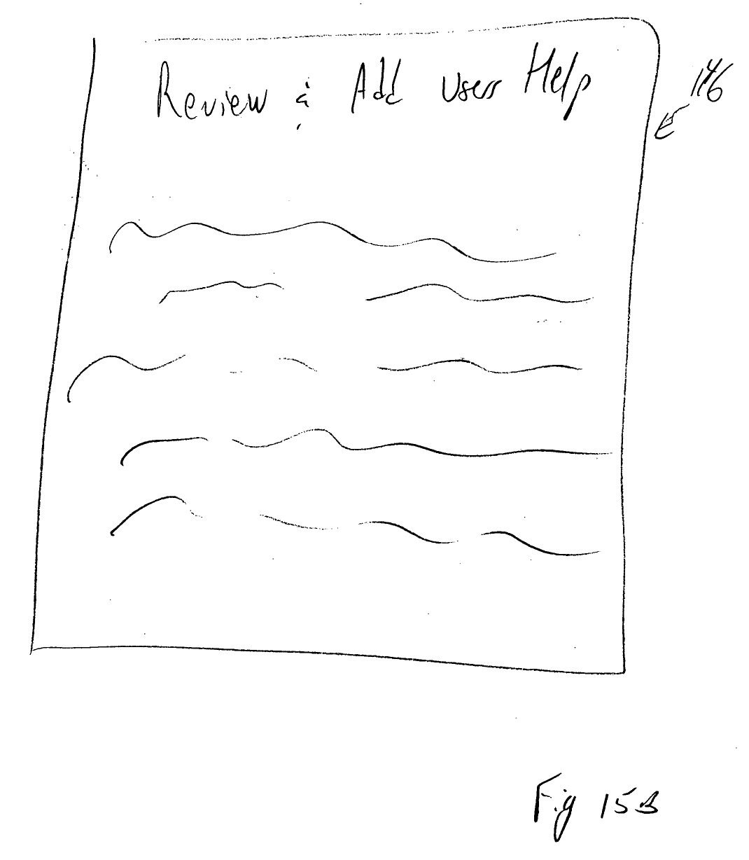

In addition to managing signature files and tracking system usage, a registered user 8 that has a requisite level of authorization, for example, a system administrator, manages other registered users 8, such as by providing or preventing access to various functionality of the present invention. FIG. 15A shows an example review and add users display screen 138 provided by the present invention after registered user 8 having sufficient rights selects manage users hyperlink 46C from system section 46 (FIG. 6). As shown in display screen 138, review users section 140 enables registered users 8 to manage other users of the present invention. Also as shown in FIG. 15A, add new user form 142 is provided that includes controls, for example, adding a new user name, password, full name, e-mail address and a plurality of yes/no radio buttons for a variety of permissions granted to the new user. For example, selections are available in form 142 to elect whether a user is entitled to upload electronic materials to site processor 4, whether a user is entitled to edit descriptions and other text describing electronic material 12, whether a user is entitled to upload a new list of e-mail recipients 6, whether a user is entitled to edit the list of e-mail recipients 6, whether a user is entitled to create a new list of e-mail recipients 6, whether a user is entitled to edit signature files, edit e-mail messages, view tracking or manage other users. For example, yes/no radio button choices are preferably available for a system administrator to define user privileges.

It is envisioned herein that the present invention be operable on one or more site processors 4 that are coupled to communication network 10. Similar to defining permissions and the UNIX operating system, system administrators typically are afforded privileged access to various functionality. By defining a new user as a system administrator, the system administrator adding the new user is expressly granting a significant amount of rights to operate and maintain the present invention. Thus, by operating the functionality afforded under systems section 46 (FIG. 6), registered users 8 are enabled to assign a company or a series of users with administrative rights, perform system tracking, and edit signature files.

FIG. 15B shows an example review and add users help display screen 146 that is provided to a user who selects help hyperlink 148. For example, help screen 146 provides information for system administrators to define access privileges for registered users 8. System administrators are preferably provided choices for information privileges that define, such as user names, passwords, uploading privileges, electronic materials 12 privileges, or the like. System administrators are instructed in display screen 146 that registered users 8 having various privileges can perform tasks that correspond to the privileges. For example, a system administrator identifies that a registered user 8 is enabled to upload lists of e-mail addresses to site processor 4 which can overwrite lists that are already on the system. Further, registered users 8 having e-mail list privileges may overwrite full e-mail lists, append names to e-mail lists, and edit individual users within a list. Also, for example, registered users 8 that are assigned a view tracking privilege are allowed to review information about e-mail projects 11, such as who has received e-mail, and who has downloaded electronic materials 12 via system 2.

Further, help screen 146 identifies that system administrators can set user privileges for registered users 8 such that the registered users 8 can function as system administrators. In this way, system administrators can define additional system administrators. Thus, FIG. 15B shows instructions with respect to defining and managing user access privileges in accordance with an example embodiment of the present invention.

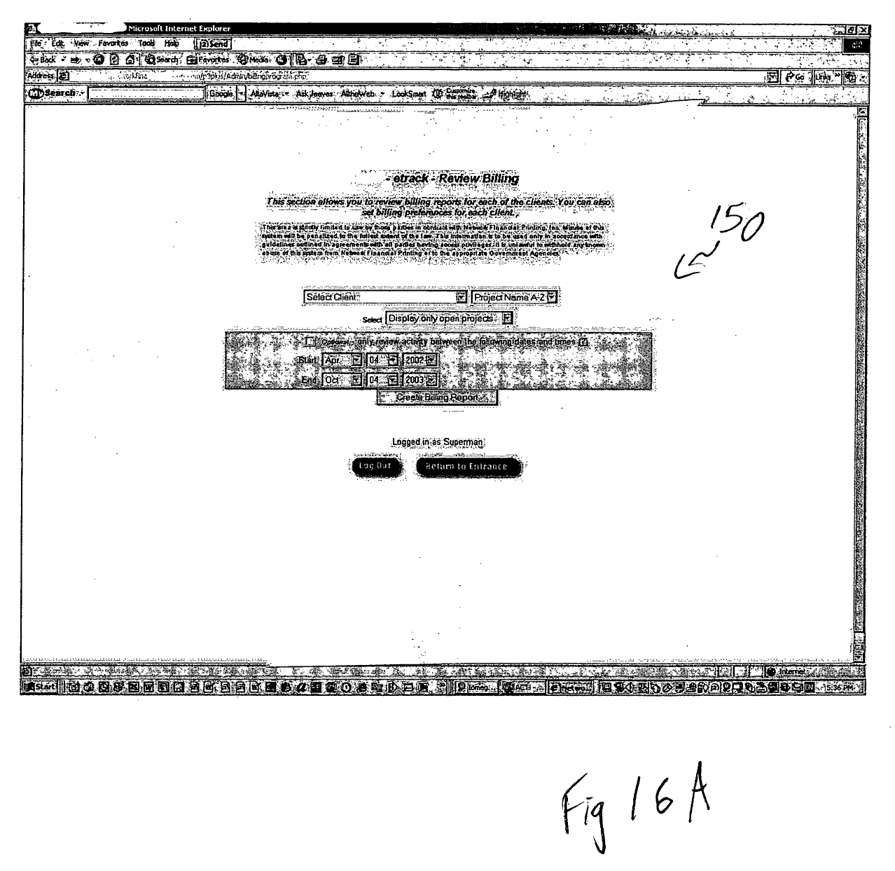

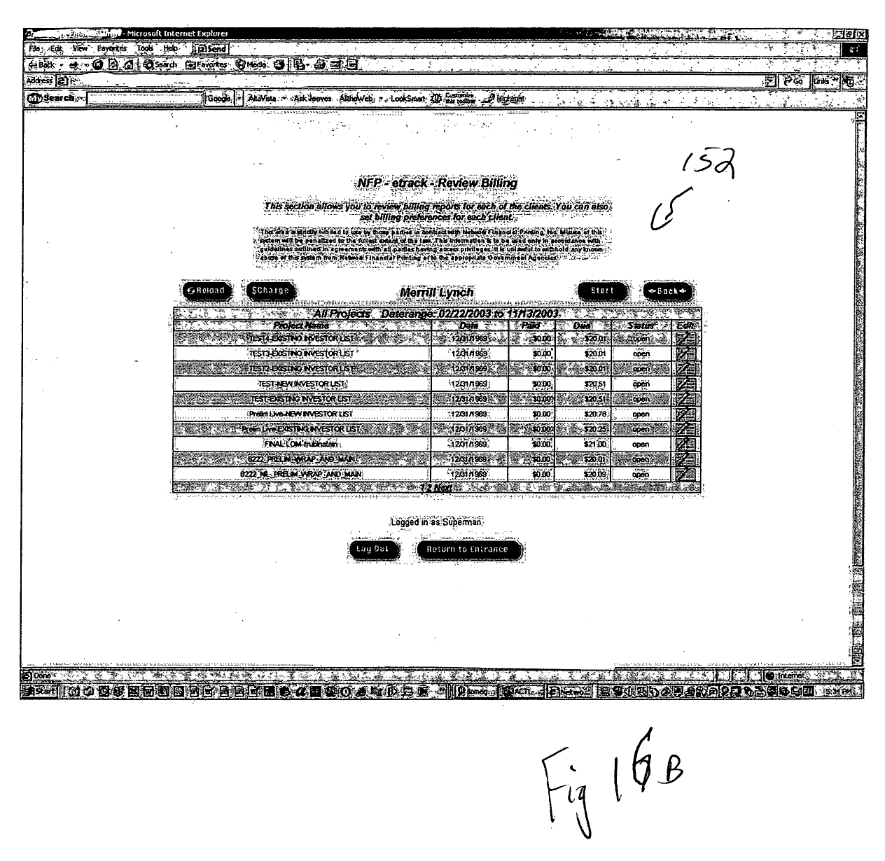

FIGS. 16A and 16B show example review billing display screens 150 and 152 that are presented to a registered user for reviewing billing related information in accordance with an example embodiment of the present invention. It is envisioned that system 2 can be used to generate revenue using a variety of pricing options. Fees can be charged for use of various features, described herein. For example, a system administrator can be charged a fee for defining new registered users 8. Also, fees can also be charged for uploading e-mail lists, uploading electronic materials, and sending e-mail. Of course, one skilled in the art will recognize that many fee arrangements can defined and provided in accordance with an example embodiment of the present invention. Example review billing display screen 150 is presented, for example, a system administrator, and is used to select a client, one or more e-mail projects 11 and a date range for identifying particular billing information.

FIG. 16B shows an example review billing display screen 152 that includes a table of e-mail projects 11, respective dates, amounts paid, amounts due and a status for e-mail projects 11, for example whether a project 11 has not been completely paid for (represented as “open”). Other ways of providing information directed accounting are possible and envisioned herein. For example, the table shown in FIG. 16B can include hyperlinks that provide details regarding a particular e-mail project 11 that is selected.

Thus, the present invention provides a revolutionary way for delivery and tracking of time-sensitive information, for example, for the municipal industry. The present invention provides users the ability to post, track and manage electronic materials 12 in order to be assured that information is provided to a specific party in a timely manner. By providing tracking functionality, the present invention enables users to determine who has received e-mail messages 14, and whether users have downloaded electronic materials 12. In this way, information is provided for registered users 8 that will enable them to identify the distribution of important electronic information.

Further, the present invention enables administration processes to ensure security. For example, a top-level system administrator can choose to add individual users and assign specific privileges to ensure security and privacy. Further, the present invention allows users to easily manage other users, and to view electronic materials on-line from any computer operating Internet web browser software.

The present invention provides an advanced on-line file management distribution system that is easy, secure and efficient.

Although the present invention has been described in relation to particular embodiments thereof, many other variations and modifications and other uses will become apparent to those skilled in the art. Therefore, that the present invention is not limited by the specific disclosure.

What is claimed is:

1. A system for disseminating an electronic material over a network, the system comprising:
a list defining module that defines a list of at least one intended recipient of the electronic material;
an electronic materials receiving module that receives and stores the electronic material from a user to be transmitted to the at least one intended recipient on a site processor;
a properties association module that defines properties to be associated with the electronic material;
a generate and send message module that provides a message to the at least one intended recipient, wherein the message includes a hyperlink to the electronic material; and
a system tracking module that tracks whether the at least one intended recipient receives the electronic material.

2. The system of claim 1, further comprising a user management module that is used by the user to allow additional users to disseminate at least one of the electronic material and other electronic material.

3. The system of claim 2, wherein the user management module provides various levels of authorization for the additional users.

4. The system of claim 1, wherein the electronic material comprises at least one of annual reports, bank books, compliance documents, litigation-related materials, mutual fund related information, Preliminary Official Statements, private placements, prospectuses, proxy statements, registration statements and research reports.

5. The system of claim 1, further comprising a project module that identifies the message, the electronic material and the at least one intended recipient with a unique project name.

6. The system of claim 5, wherein the project module further enables a user to duplicate at least one of the message, the electronic material and an identifier of the at least one intended recipient associated with the unique project name.

7. The system of claim 1, wherein the message further includes a hyperlink to a Preliminary Official Statement.

8. The system of claim 1, wherein the message includes a control for forwarding the message to another intended recipient when the party who receives the message is not one of the at least one intended recipient.

9. The system of claim 1, wherein the list includes at least one respective e-mail address for the at least one intended recipient.

10. The system of claim 9, further comprising a checking module that tests the at least one e-mail address for accuracy.

11. The system of claim 10, wherein the at least one e-mail address is accurate when the at least one e-mail address complies with formatting standards.

12. The system of claim 1, wherein the list defining module further receives electronic e-mail list information, the e-mail list information representing intended recipients and e-mail addresses thereof.

13. The system of claim 12, wherein the list defining module creates an e-mail list based on the electronic e-mail list information.

14. A method for disseminating an electronic material over a network, the method comprising:
defining a list of at least one intended recipient of the electronic material;
receiving and storing the electronic material from a user to be transmitted to the at least one intended recipient on a site processor;
defining properties to be associated with the electronic material;
generating and sending a message to the at least one intended recipient, wherein the message includes a hyperlink to the electronic material; and
tracking whether the at least one intended recipient receives of the electronic material.

15. The method of claim 14, further comprising enabling the user to allow additional users to disseminate at least one of the electronic material and other electronic material.

16. The method of claim 15, wherein the step of enabling includes providing various levels of authorization for the additional users.

17. The method of claim 14, wherein the electronic material comprises at least one of annual reports, bank books, compliance documents, litigation-related materials, mutual fund related information, Preliminary Official Statements, private placements, prospectuses, proxy statements, registration statements and research reports.

18. The method of claim 14, further comprising identifying the message, the electronic material and the at least one intended recipient with a unique project name.

19. The method of claim 18, further comprising duplicating at least one of the message, the electronic material and an identifier of the at least one intended recipient associated with the unique project name.

20. The method of claim 14, wherein the message further includes a hyperlink to a Preliminary Official Statement.

21. The method of claim 14, wherein the message is an e-mail message.

22. The method of claim 21, wherein the e-mail message includes a control for forwarding the e-mail message to another intended recipient when the party who received the e-mail is not one of the at least one intended recipient.

23. The method of claim 14, wherein the list includes at least one respective e-mail address for the at least one intended recipient.

24. The method of claim 23, further comprising testing the at least one e-mail address in the list for accuracy.

25. The method of claim 24, wherein the at least one e-mail address is accurate when the e-mail address complies with formatting standards.

26. The method of claim 14, further comprising receiving electronic list information, the electronic list information representing intended recipients and respective e-mail addresses therefor.

27. The method of claim 26, wherein the list is based on the electronic list information.

28. A method for disseminating electronic materials over a network, the method comprising:
defining an e-mail list of intended recipients;
receiving electronic materials to be transmitted to members on the e-mail list;
generating and sending e-mail messages to members of the list;
associating properties with the electronic materials;
tracking system usage; and
managing users.

29. A system for disseminating an electronic material over a network, the system comprising:
an e-mail list defining module that defines an e-mail list of at least one e-mail address of an intended recipient of the electronic material;
an electronic materials receiving module that receives and stores the electronic material from a registered user to be transmitted to the at least one intended recipient on a site processor;
a properties association module that defines properties to be associated with the electronic material;
a generate and send e-mail message module that provides an e-mail message to the at least one intended recipient, wherein the e-mail message includes a hyperlink to the electronic material;
a system tracking module that tracks whether the intended recipient receives the electronic material; and
a signature management module that provides at least electronic signature to be appended to the e-mail message.

30. A method for disseminating an electronic material over a network, the method comprising:
defining an e-mail list of at least one e-mail address of an intended recipient of the electronic material;
receiving and storing the electronic material from a registered user to be transmitted to the at least one intended recipient on a site processor;
defining properties to be associated with the electronic material;
generating and sending an e-mail message to the at least one intended recipient, wherein the e-mail message includes a hyperlink to the electronic material; and
tracking the intended recipient's reception of the electronic material.
